(19) United States
(12) Patent Application Publication
(10) Pub. No.: US 2003/0140081 A1
(43) Pub. Date: Jul. 24, 2003

(54) Method and system of accessing shared resources using configurable management information bases

(76) Inventors: Jeremy S. de Bonet, N. Andover, MA (US); Todd A. Stiers, Berkeley, CA (US); Jeffrey R. Annison, Clayton, CA (US)

Correspondence Address: GRAY, CARY, WARE & FREIDENRICH LLP, 1221 SOUTH MOPAC EXPRESSWAY, SUITE 400, AUSTIN, TX, 78746-6875, US

(21) Appl. No.: 10/345,101

(22) Filed: Jan. 15, 2003

Related U.S. Application Data
(60) Provisional application No. 60/348,566, filed on Jan. 15, 2002.
(60) Provisional application No. 60/349,424, filed on Jan. 18, 2002.
(60) Provisional application No. 60/349,344, filed on Jan. 18, 2002.

(51) Int. Cl. G06F 9/00

(52) U.S. Cl. 709/100

(57) ABSTRACT

A method and system can be used to dynamically establish relationships between Simple Network Management Protocol (SNMP) Object Identifiers (OIDs) and data resources with which they are associated. In one embodiment, user-friendly names may be used to identify and access the resources, so that the dynamic association between OID and resource can be achieved by a mapping mechanism that allows for dynamic association between OID and resource name. An OID-name map may be used to link a resource name to one or more OIDs. The map can be generated and modified by altering configuration files, and without having to change software, firmware or hardware. Therefore, generating a new map or modifying an existing map for a new operating environment can be performed quickly and easily.

### RELATED APPLICATIONS

This application claims priority under 35 U.S.C. § 119(e) to U.S. patent application Ser. No. 60/349,424, entitled “Network Proxy Platform that Simultaneously Supports Data Transformation, Storage, and Manipulation for Multiple Protocols” by de Bonet et al., filed on Jan. 18, 2002; No. 60/349,344 entitled “A Modular Plug-In Transaction Processing Architecture” by de Bonet et al. filed Jan. 18, 2002; and No. 60/348,566, entitled “Fully Configurable Management Information Bases for the Simple Network Management Protocol” by Annison et al., filed on Jan. 15, 2002. This application is related to U.S. patent application No. ______ (Attorney Docket No. IDET1130-1), entitled “Method And System Of Performing Transactions Using Shared Resources And Different Applications” filed on Jan. 14, 2003. All patent applications referenced in this paragraph are assigned to the current assignee hereof and incorporated herein by reference.

### FIELD OF THE INVENTION

The invention relates in general to object identifiers, and more particularly, to methods and systems of generating and modifying configurations of management information bases for networks.

### DESCRIPTION OF THE RELATED ART

The Simple Network Management Protocol (“SNMP”) is the de facto standard used to monitor and manage electronic network infrastructure. SNMP relies on a serial mapping of integers separated by periods (“.”) to map to a globally specific object. The objects that SNMP uses are often formatted in a Management Information Base (“MIB”), which like SNMP, is formatted for use in network management software as a map to objects using object identifiers (“OIDs”).

Historically, SNMP was designed for use on hardware devices and hard-coded into the firmware of those devices. As network infrastructure became digital and as the Internet began to grow, SNMP became the standard to monitor and manage these networks.

As the networks grew, the use of SNMP spread. With the investments in SNMP monitoring and SNMP-based hardware in place, SNMP began to be used as a tool to not only monitor network nodes (a node can be a participant in a network), but to actually monitor specific pieces of software on those nodes.

The prior limitations of firmware and small footprint devices no longer constrain the ability of the developer to rapidly redesign and redeploy many configurations of an SNMP server (an “agent”) in their software. However, the tedious, non-standard nature of connecting SNMP OIDs within modern software is a bottleneck in the process of using and deploying SNMP.

### SUMMARY OF THE INVENTION

A method and system can be used to dynamically establish relationships between Simple Network Management Protocol (SNMP) Object Identifiers (OIDs) and data resources with which they are associated. In one embodiment, user-friendly names may be used to identify and access the resources, so that the dynamic association between OID and resource can be achieved by a mapping mechanism that allows for dynamic association between OID and resource name. An OID-name map may be used to link a resource name to one or more OIDs. The map can be generated and modified using software and without having to change firmware or hardware. Therefore, generating a new map or modifying an existing map for a new operating environment can be performed quickly and easily. Systems may not need to be partially or completely shutdown to generate or modify the maps. The method and system are highly beneficial to companies that may incorporate third party subassemblies or code within their products.

In one set of embodiments, a method of accessing a resource can comprise receiving an SNMP-based communication that uses an OID that has been associated with the name of the resource. The method can also comprise determining the resource name that corresponds to the OID used in the request, via an OID-name map. The method can further comprise determining the data that is associated with that name via a name-resource map and accessing that resource.

In another set of embodiments, a method of using a management information base can comprise generating an OID-name map comprising OIDs and names, wherein each name corresponds to a resource and at least one OID. The method can also comprise modifying the OID-name map using software.

In a further set of embodiments, a system for using a resource can comprise an OID-name map that comprises OIDs and resource names, wherein within the OID-name map, each of the resource names corresponds to at least one OID. The system can also comprise a software component that is configured to receive a communication for an OID, access the OID-name map, determine a resource name that corresponds to the OID, and use that name to retrieve a pointer which can be used to access and manipulate the resource data.

In still further sets of embodiments, data processing system readable media can comprise code that includes instructions for carrying out the methods and may be used on the systems.

The foregoing general description and the following detailed description are exemplary and explanatory only and are not restrictive of the invention, as defined in the appended claims.

### BRIEF DESCRIPTION OF THE DRAWINGS

The present invention is illustrated by way of example and not limitation in the accompanying figures.

FIG. 1 includes an illustration of a system comprising two computers coupled to a network that can be used in an embodiment of the present invention.

FIG. 2 includes an illustration of a data processing system storage medium including software code having instructions in accordance with an embodiment of the present invention.

FIG. 3 includes an illustration of a software architecture comprising an application and a resource manager at a local computer, a network, and a remote computer in accordance with an embodiment of the present invention.

FIGS. 4-5 includes a flow diagram of a method of using the resource manager and resource maps in accordance with an embodiment of the present invention.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Reference is now made in detail to the exemplary embodiments of the invention, examples of which are illustrated in the accompanying drawings. Wherever possible, the same reference numbers will be used throughout the drawings to refer to the same or like parts (elements).

A method and system can be used to dynamically establish relationships between Simple Network Management Protocol (SNMP) Object Identifiers (OIDs) and data resources with which they are associated. In one embodiment, resource names may be used to identify and access the resources, so that the dynamic association between OID and resource can be achieved by a mapping mechanism that allows for dynamic association between OID and resource name. An OID-name map may be used to link a resource name to one or more OIDs. The map can be generated and modified using software and without having to change firmware or hardware. Therefore, generating a new map or modifying an existing map for a new operating environment can be performed quickly and easily. Systems may not need to be partially or completely shutdown to generate or modify the maps. The method and system are highly beneficial to companies that may incorporate third party subassemblies or code within their products.

As used herein, the terms “comprises,” “comprising,” “includes,” “including,” “has,” “having” or any other variation thereof, are intended to cover a nonexclusive inclusion. For example, a method, process, article, or apparatus that comprises a list of elements is not necessarily limited to only those elements but may include other elements not expressly listed or inherent to such method, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “software component” is intended to mean at least a portion of a computer program (i.e., a software application). An example includes a software module as used in object-oriented programming. Different software components may reside in the same computer program or in different computer programs on the same computer or different computers.

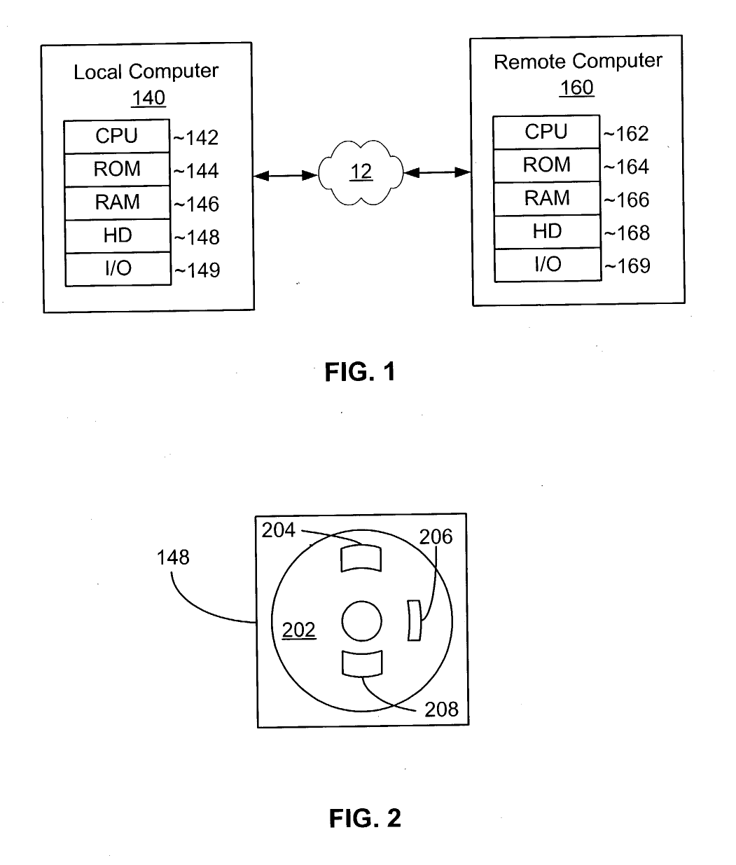

Before discussing embodiments of the present invention, an exemplary hardware architecture for using embodiments of the present invention is described. FIG. 1 illustrates such an exemplary hardware architecture and includes network 12 bi-directionally coupled to local computer 140 and remote computer 160. Network 12 may be an internal network or an external network (e.g., the Internet). Each of computers 140 and 160 may be a client computer or a server computer, as used in client-server relationships. Note that computers 140 and 160 may also have a peer-to-peer relationship.

Each of computers 140 and 160 can include a server computer, a desktop computer, a laptop computer, a personal digital assistant, a cellular phone, a workstation, or nearly other device capable of communicating over network 12. Other computers (not shown) may also be bi-directionally coupled to network 12. Although the computers are referred to as local computer 140 and remote computer 160, they may be located within separate buildings at distant locations, beside each other in the same room, or anything between those two extremes. In other words, computers 140 and 160 may be considered distinct computers connected to network 12. Alternatively, computers 140 and 160 may represent different portions of a single computer.

In an alternative embodiment, each of local computer 140 and remote computer 160 can be replaced by a plurality of computers (not shown) that may be interconnected to each other over a network or a combination of networks. For simplicity, a single system is shown for each of local computer 140 and remote computer 160.

The local computer 140 can include central processing unit (“CPU”) 142, read-only memory (“ROM”) 144, random access memory (“RAM”) 146, hard drive (“HD”) or storage memory 148, and input/output device(s) (“I/O”) 149. I/O 149 can include a keyboard, monitor, printer, electronic pointing device (e.g., mouse, trackball, stylus, etc.), or the like. Remote computer 160 can include CPU 162, ROM 164, RAM 166, HD 168, and I/O 169.

Each of the computers in FIG. 1 may have more than one CPU, ROM, RAM, HD, I/O, or other hardware components. For simplicity, each computer is illustrated as having one of each of the hardware components, even if more than one is used. Note that FIG. 1 is a simplification of an exemplary hardware configuration. Many other alternative hardware configurations are possible and known to skilled artisans.

Each of the computers 140 and 160 is an example of a data processing system. ROM 144 and 164; RAM 146 and 166; and HD 148 and 168 can include media that can be read by the CPU 142 or 162. Therefore, each of these types of memories includes a data processing system readable medium. These memories may be internal or external to the computers 140 or 160.

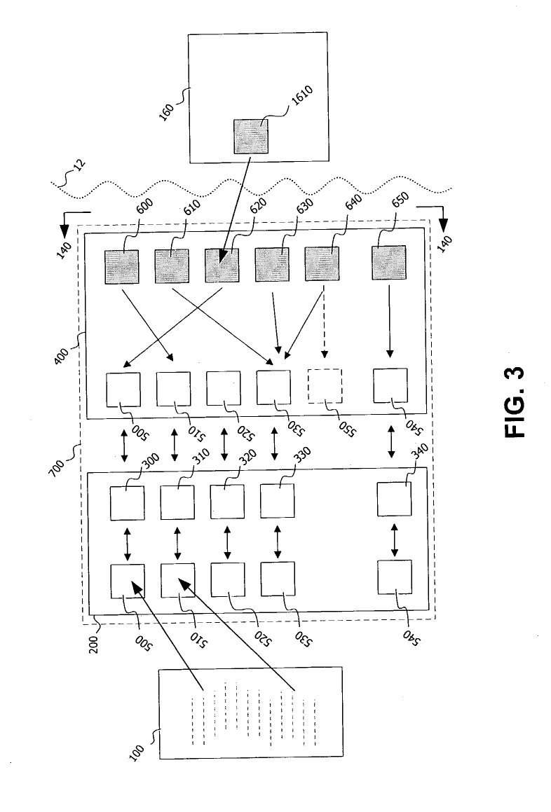

Portions of the methods described herein may be implemented in suitable software code that may reside within ROM 144 or 164, RAM 146 or 166, or HD 148 or 168. The instructions in an embodiment of the present invention may be contained on a data storage device, such as HD 148. FIG. 2 illustrates a combination of software code elements 204, 206, and 208 that are embodied within a data processing system readable medium 202, on HD 148. Alternatively, the instructions may be stored as software code elements on a DASD array, magnetic tape, floppy diskette, optical storage device, or other appropriate data processing system readable medium or storage device.

In an illustrative embodiment of the invention, the computer-executable instructions may be lines of compiled assembly, C, C⁺⁺, Java, or other language code. Other architectures may be used. For example, the functions of any one of the computers may be performed by a different computer shown in FIG. 1. Additionally, a computer program or its software components with such code may be embodied in more than one data processing system readable medium in more than one computer.

In the hardware configuration above, the various software components may reside on a single computer or on any combination of separate computers. In alternative embodiments, some or all of the software components may reside on the same computer. For example, one or more the software component(s) of local computer 140 could reside on remote computer 160, or both.

Communications between any of the computers in FIG. 1 can be accomplished using electronic, optical, radio-frequency, or other signals. For example, when a user is at local computer 140, local computer 140 may convert the signals to a human understandable form when sending a communication to the user and may convert input from a human to appropriate electronic, optical, radio-frequency, or other signals to be used by, computers 140 or 160. Similarly, when an operator is at remote computer 160, remote computer 160 may convert the signals to a human understandable form when sending a communication to the operator and may convert input from a human to appropriate electronic, optical, radio-frequency, or other signals to be used by computers 140 or 160.

Attention is now directed to the software architecture of the software in accordance with one embodiment of the present invention. The software architecture enables a dynamic association between OIDs and resources to be achieved by a mapping mechanism that allows for dynamic association between OID and resource name. The software is configured to dynamically reassign OIDs to data within a program. By configuring the system in one way, a particular OID can be used to access some data, but configured in a different way, a different OID can be used.

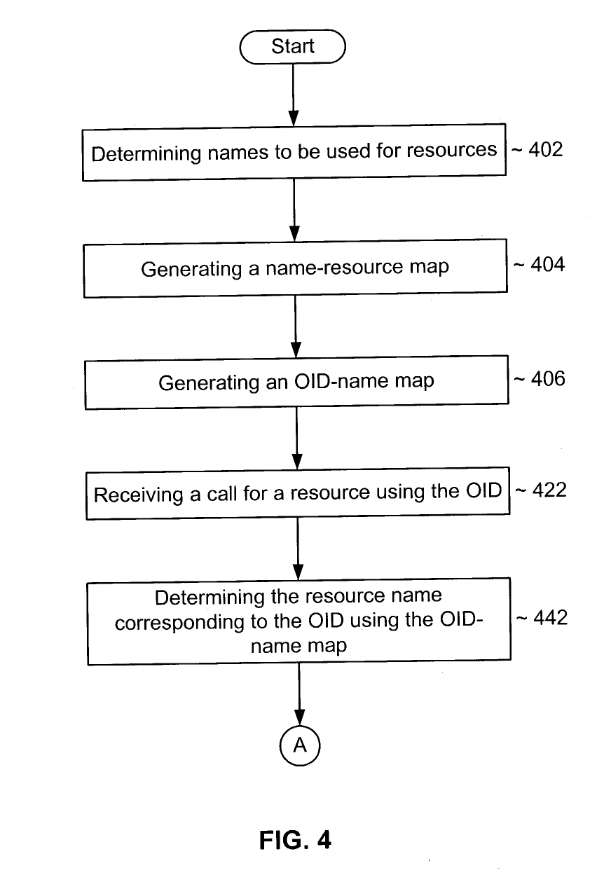

The software architecture is illustrated in FIG. 3. Resource manager 700 within local computer 140 may include a name-resource map 200 and an OID-name map 400 that can be used to make calls to resources. Resource manager 700 can include one or more software components to generate, modify, and use maps 200 and 400 when processing communications for shared resources.

The resources may include simple data, such as numbers or character strings, at least part of a structured file (e.g., an extensible Markup Language (XML) document), a data file (an image file, audio file, or the like), or the like. Therefore, the types of resources may be highly varied. In one embodiment, a resource for a file system may be used to provide nearly any information regarding the file system including available (free) disk space, a length of an encryption/decryption key, save dates of files, number of read accesses, or nearly any other statistical information that the resource may collect. Resources for other parts of the system may collect and allow access to statistics for those other parts of the systems (e.g., number of users are currently logged onto the system, number of bytes the system has transferred, etc.).

Referring to FIG. 3, application 100 may include any one or more resource names 500, 510, 520, 530, and 540. In one embodiment, resource names 500, 500, 510, 520, 530, and 540 can be user-friendly resource names which aid the programmers when generating code. Each resource name may have a corresponding pointer (300, 310, 320, 330 and 340). Alternatively, the resource name may reference the data itself (also 300, 310, 320, 330 and 340). Map 400 is flexible and can be changed dynamically without having to make any changes to software (other than possibly configuration file(s)), firmware, or hardware. The remote computer 160 may include a program with a function call 1610 for OID 620. The change to map 400 does not affect the code for the program or function call 1610 made by remote computer 160. Further, the modification may even be performed while the program, which has function call 1620, at remote computer 160 is running.

Remote computer 160, such as a network management station, may include the function call 1610 for OID 620 at local computer 140 via network 12. Resource manager 700 may use OID-name map 400 to determine that resource name 500 corresponds to OID 620. Resource manager may use name-resource map 200 to determine pointer 300 corresponds to resource name 500. Pointer 300 may be used to locate the resource used for the function call. Alternatively, reference number 300 may be the data itself, rather than a pointer.

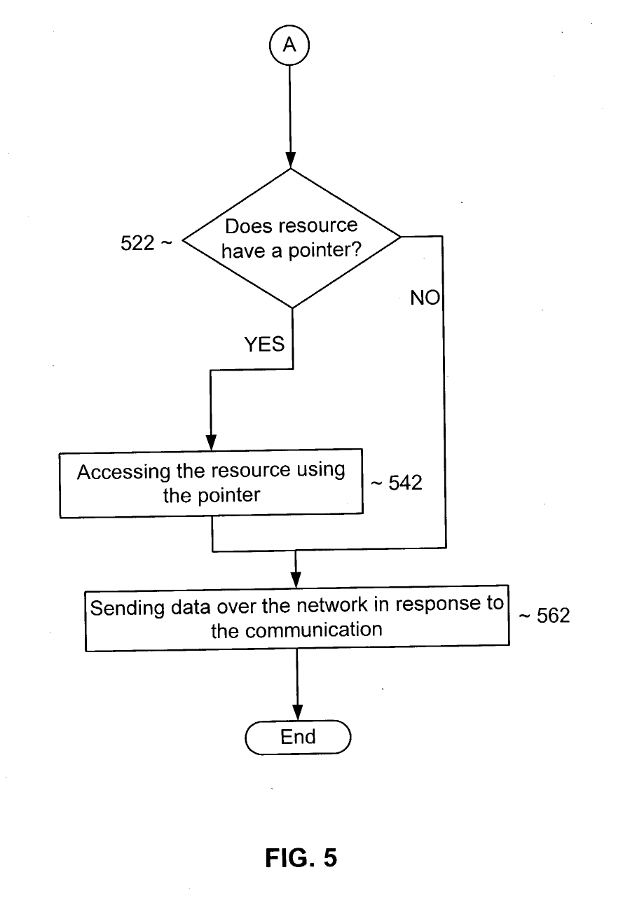

Attention is now directed to FIGS. 4-5 that includes illustrations for a process flow diagram for using shared resources. Referring to FIG. 4, the method can comprise determining names to be used for resources (block 402), generating a name-resource map (block 404), generating an OID-name map (block 406), receiving a call for a resource using the OID (block 422), determining the resource name corresponding to the OID using the OID-name map (block 442), and determining whether the resource has a corresponding pointer (diamond 522 in FIG. 5). If the resource has a corresponding pointer, the method can comprise accessing the resource using the pointer (block 542). Otherwise, the act may be bypassed (i.e., not performed). The method can further comprise sending data over the network in response to the communication (block 562).

Note that not all of the activities described in the process flow diagrams are required, that a limitation within a specific activity may not be required, and that further activities may be performed in addition to those illustrated. Also, some of the activities may be performed substantially simultaneously during with other activities. After reading this specification, skilled artisans will be capable of determining what activities can be used for their specific needs.

Attention is now directed to a more detailed description of the methods as shown in FIGS. 4-5 with references to FIG. 3, as appropriate. For the purposes of discussion, local computer 140 comprises all items on the left-hand side of network 12 as shown in FIG. 3, and remote computer 160 comprises a network monitoring station. Remote computer 160 may include a software component that is configured to make function call 1610. Function call 1610 may need to access a resource at local computer 140 corresponding to OID 620 and using network 12.

Before the function call 1610 can be processed at local computer 140, maps and code for the resources need to be in place at local computer 140. In one embodiment, one of the resources may include the available disk space at local computer 140. Therefore, the method can comprise determining names to be used for resources (block 402 in FIG. 4). In one embodiment, a resource that corresponds to available disk space may have a resource name, such as “free_disk_space” instead of using an OID.

After the names are determined, two associative arrays using resource names 500-540 can be generated. A first associative array may include a key of resource name (500-540) and a value of pointer (300-340) that has the address of the resource or it could refer to the resource itself. Therefore, the method can comprise generating name-resource map 200 (block 404), which is the first associative array. A one-to-one relationship may be used for resource name (500-540) to pointer (300-340) though many-to-one mappings are also possible in some embodiments.

In one embodiment, a resource initialization can be performed, for example, using the syntax:

[VARSET] FREE::DISK::SPACE 23.

Resource name 500 is “FREE::DISK::SPACE,” and resource 300 has a value of 23. Alternatively, an application program interface (“API”) function call could be used to set resource values, for example the function call may be:

bool VarSetOkay=VarSet(“FREE::DISK::SPACE”,23).

Variable set commands may be used in generating map 200.

The API retrieval from map 200 may be a function call:

int aVariableName=VarGet(“FREE::DISK::SPACE”,−999).

If −999 is returned, the resource was not found at local computer 140. Otherwise, the value is returned.

A second associative array may include a key of OID (600-650) and a value of resource name (500-540). Alternatively, the name (500-540) may be the key and OID (600-650) may be the value. Therefore, the method can comprise generating OID-name map 400 (block 406), which is the second associative array. Map 400 may be generated potentially by reading in the details from a configuration file or the like.

A configuration function in a configuration file can be used to generate map 400. In one non-limiting embodiment, the format of the command can include:

[DEFINE_OID] <oid> <type> <variable> <readGroup> <writeGroup>,

wherein:

<oid> can be the object identifier;

<type> can be the variable type of the resource name, which will usually be a character string, although other variable types may be used;

<variable> can be the resource name;

<readGroup> can designate who has read access privilege; and

<writeGroup> can designate who has write access privilege.

A non-limiting example may include:

[DEFINE_OID] 1.3.6.1.4.1.11211.3.1.1.1.1 str FREE::DISK::SPACE public operator.

In the non-limiting example, resource name 500 is FREE::DISK::SPACE, and OID 620 is 1.3.6.1.4.1.11211.3.1.1.1.1.

OID-name map 400 and name-resource map 200 may lie within or be accessible to resource manager 700. The resource manager 700 may reside in HD 148 and be loaded into RAM 146 of local computer 140 when it is being used.

The method can comprise receiving a call for a resource using the OID (block 422 in FIG. 4). Referring to FIG. 3, remote computer 160 may include an application having a function call 1610 that is transmitted in a communication using SNMP over network 12 to local computer 140. OID 620, which may have a value of 1.3.6.1.4.1.11211.3.1.1.1.1, may be passed with function call 1610 to obtain available disk space at local computer 140. Function call 1610 may be received by resource manager 700.

The method can also comprise determining the resource name corresponding to the OID using the OID-name map (block 442). Resource manager 700 may access OID-name map 400 to determine that OID 620 (1.3.6.1.4.1.11211.3.1.1.1.1 in the example) corresponds to resource name 500 (FREE::DISK::SPACE in the example).

The method can further comprise determining whether the resource has a corresponding pointer (diamond 522 in FIG. 5). Such a determination may be made using name-resource map 200. If the resource has a pointer, the method can comprise accessing the resource using the pointer (block 542). After obtaining resource name 500 (FREE::DISK::SPACE in the example), resource manager 700 may determine if a corresponding pointer for resource name 500 is within map 200. In this example, resource manager can determine that pointer 300, corresponds to resource name 500. Using pointer 300, resource manager 700 can access the resource requested by function call 1610 (yielding 23 in the example).

In alternative embodiment, reference numbers 300, 310, 320, 330, and 340 may represent data itself rather than a pointer to data. The resources may be accessed directly by using the resource names 500, 510, 520, 530, and 540. In such an embodiment (“No” branch from diamond 522), the method can bypass block 542 in FIG. 5.

The method can comprise sending data over the network in response to the communication (block 562). After accessing the resource, local computer 140 may pass the requested data, which is the available disk space at local computer 140, back to remote computer 160.

The method and system are powerful in that the software architecture allow for a dynamic reconfiguration between OIDs and resources. The mapping mechanism described above allows for dynamic association between OID and resource name. The software is configured to dynamically reassign OIDs to data within a program. OID-name map 400 and name-resource map 200 may be modified with relative ease. In one embodiment, map 200 or 400 may be modified by changing configuration file(s). The modification can be made without having to change software (other than possibly configuration files), firmware, or hardware. The modification may be made to a map (e.g., configuration file) while a program that accesses a resource within the map is running.

The flexibility and ability to dynamically change OID-name maps without having to change firmware or hardware is highly beneficial when modifying existing configurations or adding new resources. Some hardware may be difficult to reach to replace. In other instances, changing firmware may require shutting down at least part of a system to remove a board to replace a ROM or other similar memory or code. The method and system can obviate the need to partially or completely shutting down a system.

The method and system may also be beneficial to companies that integrate subassemblies from other companies within their own products. The subassemblies can be made that use OIDs that are common with SNMP communications. However, the OID-name map allows the OIDs to be used by the subassembly while other parts of the same product may use the user-friendly names.

The modification may be performed using the configuration commands described previously in this specification. Resources, resource names, OIDs, and pointers may be added, deleted or reconfigured in many different ways. The embodiments described below are non-limiting, illustrative embodiments. Modifications to maps 200 and 400 may be performed using resource manager 700. Within resource manager 700, software component(s) used to modify maps 200 and 400 may be the same or a different software component used to process communications to access resources.

In one embodiment, OID 640 may have originally corresponded to a resource having resource name 550. Data from a resource corresponding to resource name 550 may have been merged into a different resource corresponding to resource name 530. Map 400 can be modified by changing OID 640's corresponding entry in the associative array to replace resource name 550 with resource name 530. The deletion of name 550 its former correspondence with OID 640 is illustrated as dashed lines in FIG. 3. Note that OIDs 610, 630, and 640 map to resource name 530 as illustrated in FIG. 3.

In another embodiment, local computer 140 may be collecting data for its own use corresponding to a resource having resource name 540 and located at the address of pointer 340. Originally, map 400 may not have entries for resource name 540 and OID 650. At a later time, a determination can be made to make the resource at local computer 140 available to remote computer 160. A new pair of entries can be made into the associative array of map 400 to add resource name 540 and OID 650. In this manner, new resources may be easily added at any time.

In still another embodiment, a new resource may be added. Entries for its resource name and point may be added to map 200. Alternatively, a resource may be deleted by removing its name-resource pair from map 200. Modifications to map 400 may or may not be performed in response to modifications to map 200. Therefore, modifications to maps 200 and 400 may occur in a dependent or independent manner.

The system and method allow the use of commands in SNMP to be sent and received in forms that computers use in transferring data over networks. In other words, the get or set commands with OIDs can still be transmitted over a network. However, a receiving computer may take an SNMP-formatted function call and convert it to a format that is used at the receiving computer using a resource name, and potentially a pointer to the resource.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims.

What is claimed is:

1. A method of using a system having a resource, wherein the method comprises:
receiving a communication for a first resource, wherein the communication includes a first OID of the first resource; and
determining a first name of the first resource corresponds to the first OID using an OID-name map; and
accessing the first resource after determining the first name of the first resource.

2. The method of claim 1, further comprising determining a first pointer of the first resource corresponds to the first name using a name-resource map, wherein accessing the first resource comprises accessing the first resource using the first pointer.

3. The method of claim 2, wherein the name-resource map further comprises:
other names; and
other pointers, wherein each of the other pointers corresponds to only one of the other names.

4. The method of claim 2, further comprising modifying the name-resource map.

5. The method of claim 1, wherein the communication is received over a network using SNMP.

6. The method of claim 1, wherein the OID-name map further comprises:
other OIDs for other resources; and
other names, wherein each of the other names corresponds to at least one of the first and other OIDs.

7. The method of claim 6, wherein more than one OID corresponds to the first name.

8. The method of claim 1, further comprising sending a datum over a network in response to the communication, wherein:
accessing the first resource comprises accessing the first resource for the datum; and
sending is performed after accessing the first resource.

9. The method of claim 1, further comprising modifying the OID-name map.

10. The method of claim 1, wherein modifying the OID-name map is performed while a program that accesses the first resource is running.

11. A method of using a management information base comprising:
generating an OID-name map comprising OIDs and names, wherein each name corresponds to a resource and at least one OID; and
modifying the OID-name map using software.

12. The method of claim 11, wherein modifying comprises modifying the OID-name map, such that:
before modifying, a first OID corresponds to a first name; and
after modifying, the first OID corresponds to a second name different from the first name.

13. The method of claim 11, wherein modifying comprises modifying the OID-name map, such that:
before modifying, a first name corresponds to a first OID; and
after modifying, the first name corresponds to a second OID different from the first OID.

14. The method of claim 11, wherein modifying comprises deleting a name or an OID from the OID-name map.

15. The method of claim 11, wherein modifying comprises adding a name or an OID to the OID-name map.

16. The method of claim 11, wherein modifying is performed without making any firmware or hardware change.

17. The method of claim 11, wherein modifying the OID-name map is performed while a program that accesses the first resource is running.

18. A data processing system readable medium having code embodied therein, the code comprising:
an instruction for accessing a communication for a first resource, wherein the communication includes a first OID of the first resource; and
an instruction for using an OID-name map to determine a first name of the first resource corresponds to the first OID; and
an instruction for accessing the first resource after determining the first name of the first resource.

19. The data processing system readable medium of claim 18, wherein:
the code further comprises an instruction for determining a first pointer of the first resource corresponds to the first name using a name-resource map; and
the instruction for accessing the first resource comprises an instruction for accessing the first resource using the first pointer.

20. The data processing system readable medium of claim 19, wherein the name-resource map further comprises:
other names; and
other pointers, wherein each of the other pointers corresponds to only one of the other names.

21. The data processing system readable medium of claim 19, wherein the code further comprises an instruction for modifying the name-resource map.

22. The data processing system readable medium of claim 18, wherein the communication uses SNMP.

23. The data processing system readable medium of claim 18, wherein the OID-name map further comprises:
other OIDs for other resources; and
other names, wherein each of the other names corresponds to at least one of the first and other OIDs.

24. The data processing system readable medium of claim 23, wherein more than one OID corresponds to the first name.

25. The data processing system readable medium of claim 18, wherein:
the code further comprises an instruction for sending a datum over a network in response to the communication;
the instruction for accessing the first resource comprises an instruction for accessing the first resource for the datum; and
the instruction for sending is executed after the instruction for accessing the first resource.

26. The data processing system readable medium of claim 18, wherein the code further comprises an instruction for modifying the OID-name map.

27. The data processing system readable medium of claim 26, wherein the instruction for modifying is configured to allow execution of the modification while a program that accesses the first resource is running.

28. A data processing system readable medium having code embodied therein, the code comprising:
an instruction for accessing an OID-name map comprising OIDs and names, wherein each name corresponds to a resource and at least one OID; and
an instruction for modifying the OID-name map using software.

29. The data processing system readable medium of claim 28, wherein the instruction for modifying comprises an instruction for modifying the OID-name map, such that:
before executing the instruction for modifying, a first OID corresponds to a first name; and
after executing the instruction for modifying, the first OID corresponds to a second name different from the first name.

30. The data processing system readable medium of claim 28, wherein the instruction for modifying comprises an instruction for modifying the OID-name map, such that:
before executing the instruction for modifying, a first name corresponds to a first OID; and
after executing the instruction for modifying, the first name corresponds to a second OID different from the first OID.

31. The data processing system readable medium of claim 28, wherein the instruction for modifying comprises an instruction for deleting a name or an OID from the OID-name map.

32. The data processing system readable medium of claim 28, wherein the instruction for modifying comprises an instruction for adding a name or an OID to the OID-name map.

33. The data processing system readable medium of claim 28, wherein the instruction for modifying is performed without making any firmware or hardware change.

34. The data processing system readable medium of claim 28, wherein the instruction for modifying is configured to allow execution of the modification while a program that accesses the first resource is running.

35. A system for using a resource comprising:
an OID-name map that comprises OIDs and resource names of resources, wherein each of the resource names corresponds to at least one OID;
a first software component that is configured to:
receive a communication for a first OID of a first resource;
access the OID-name map; and
determine a first resource name that corresponds to the first OID.

36. The system of claim 35, further comprising a name-resource map that comprises the resource names and pointers that correspond to the resource names, wherein the first software component is further configured to:
access the name-resource map; and
determine a first pointer of a first resource that corresponds to the first resource name.

37. The system of claim 35, wherein:
more than one OID refers the first resource name; and
each resource name refers to only one resource.

38. The system of claim 35, wherein the communication is in SNMP.

39. The system of claim 35, further comprising a second software component is configured to modify the OID-name map.

40. The system of claim 39, wherein modification of the OID-name map is performed without changing firmware or hardware.

41. The system of claim 39, wherein the second software component is configured to allow modification of the OID-name map while a program that accesses the first resource is running.
